(19) United States
(12) Patent Application Publication
(10) Pub. No.: US 2026/0054179 A1
(43) Pub. Date: Feb. 26, 2026

(54) ON-DEVICE LOCALIZATION AND TRACKING WITHOUT KEYFRAMES

(71) Applicant: Niantic Spatial, Inc., San Francisco, CA (US)

(72) Inventors: Riyaan Bakhda, San Francisco, CA (US); Anvith Ekkati, Fremont, CA (US); Haomin Zhu, Belmont, CA (US); Erik Marshall Murphy-Chutorian, Palo Alto, CA (US); Victor Adrian Prisacariu, Oxford (GB); Tommaso Cavallari, Oxford (GB)

(21) Appl. No.: 19/303,699

(22) Filed: Aug. 19, 2025

Related U.S. Application Data
(60) Provisional application No. 63/685,173, filed on Aug. 20, 2024.

(51) Int. Cl. A63F 13/65; A63F 13/211; A63F 13/213; A63F 13/216

(52) U.S. Cl. CPC A63F 13/65; A63F 13/211; A63F 13/213; A63F 13/216; A63F 2300/8082

(57) ABSTRACT

A localization approach uses a 3D map for an area made up of 3D points. A mobile device downloads the 3D map and localizes itself against the 3D map by comparing images captured by a camera on the mobile device to the 3D map. On-device localization obviates the need to send keyframes to the server and greater localization accuracy may be achieved as a larger number of images (e.g., all of the images captured by the device's camera) may be compared to the map. Tracking may also be performed on-device by comparing additional image captured by a camera on the mobile device to the 3D map in view of sensor data (e.g., inertial data).

### CROSS-REFERENCE TO RELATED APPLICATIONS

The present application claims the benefit of U.S. Provisional Patent Application No. 63/685,173 filed Aug. 20, 2024, which is incorporated by reference.

### BACKGROUND

### 1. Technical Field

The subject matter described relates generally to device localization and tracking, and, in particular, to localizing and tracking a device without sending keyframes to a server.

### 2. Problem

Localization in the process of determining the location of a device in an environment. One approach to localization for Augmented Reality (AR) applications is to provide one or more images captured by a camera on the device (referred to as “keyframes”) to a server, which compares the keyframes to a 3D map of the scene to find the poses (positions and orientations) of the device that best matches features extracted from the keyframes to the 3D map. Once the keyframe poses are provided back to the client device, the client device can perform tracking from the keyframe poses to provide real-time pose determination. This keyframe matching approach without prior information from previous localizations and IMU data between consecutive keyframes has various drawbacks, including being computationally expensive because the keyframes are not directly comparable with the 3D map and using significant bandwidth because images are passed from the device to the server for processing. Furthermore, because images are being sent to the server, privacy-preserving processes are typically needed to redact or otherwise obscure personally identifiable information in the keyframes (e.g., license plates, faces, etc.). Moreover, the on-device tracking in its own coordinate frame can create drift from the keyframe poses serving as baseline pose for the tracking.

### SUMMARY

The above and other problems may be addressed by using a localization approach that uses a 3D map for an area. The 3D map may be a point cloud made up of 3D points or use any other appropriate representation, such as a neural network. A mobile device (e.g., a smartphone) may download the 3D map and localize itself against the 3D map by comparing images captured by a camera on the mobile device to the 3D map. Because the localization can be performed on-device, keyframes need not be sent to the server and greater localization accuracy may be achieved as a larger number of images (e.g., all of the images captured by the device's camera) may be compared to the map. Although the localization approach is described in the context of comparing camera images to visual descriptors, it should be appreciated that a similar approach may be adopted for comparing other types of sensor data (e.g., lidar data) to 3D maps having corresponding descriptors.

In various embodiments, each point of the 3D map includes a descriptor that includes information about the appearance of the point. The 3D map can initially be built from videos of the area from different viewpoints. Once the 3D map has been built, it may include sufficient information about the appearance of the points without using the original images used to build the descriptors for the points. At localization time, a user's device captures one or more images of the area and the device can be localized by comparing patches of the one or more images to the descriptors to find the pose that is the best match across all of the patches considered according to a specified metric. Once the device has been localized, improved tracking can be provided by continuing to localize against the map and combining the results of localization with an expected pose based on the prior localized position and inertial data indicating how the device has moved since the previous localization.

In some embodiments, the 3D map may also be expanded locally on the device by adding new 3D points with corresponding descriptors generated from the images captured by the devices camera (e.g., if the user takes device beyond the edge of the initial 3D map) or by amending 3D points by updating the corresponding descriptors based on captured images (e.g., to reflect a crack that has opened up in a sidewalk paving slab since the initial 3D map was created).

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for providing on-device localization and tracking, according to one embodiment.

FIG. 4 is a block diagram of the positioning module shown in FIG. 3, according to one embodiment.

FIG. 5 is a flowchart of a process for on-device localization and tracking, according to one embodiment.

FIG. 6 illustrates an example computer system suitable for use in the networked computing environment of FIG. 3, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where device localization and tracking is desirable. In addition, the inherent flexibility of computer-based systems allows for a great variety of possible configurations, combinations, and divisions of tasks and functionality between and among the components of the system.

### Example Location-Based Parallel Reality Game

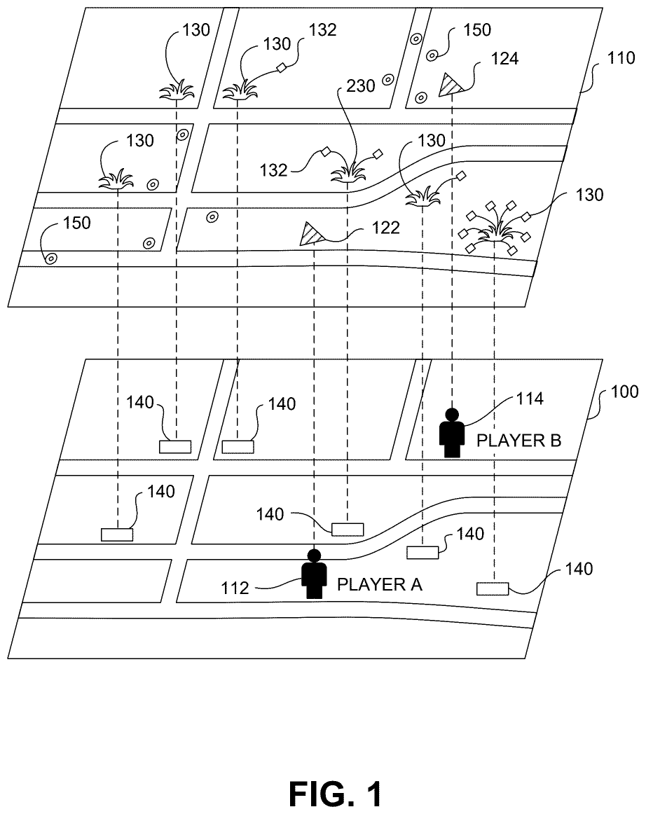

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

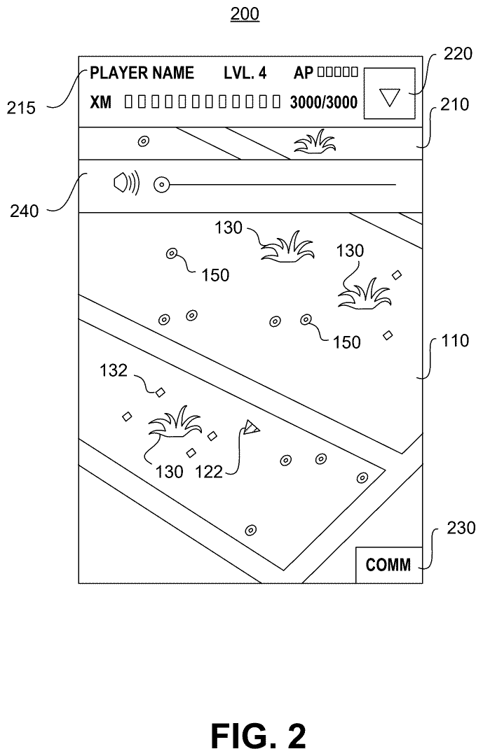

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

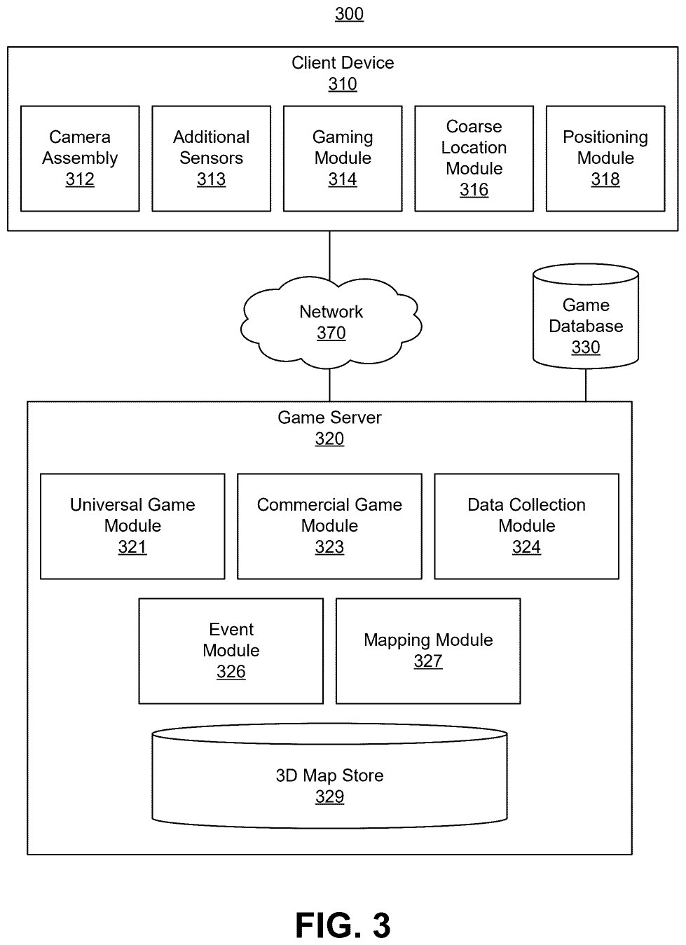

FIG. 3 illustrates one embodiment of a networked computing environment 300 suitable for providing on-device localization and tracking. The networked computing environment 300 uses a client-server architecture, where a game server 320 communicates with a client device 310 over a network 370. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 may provide for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a coarse location module 316, and a positioning module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The pose may be determined based on pose estimation algorithms, or other sensors. The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include one or more additional sensors 313 for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The coarse location module 316 can be any device or circuitry for determining a coarse geolocation of the client device 310. For example, the coarse location module 316 can determine actual or relative geolocation by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the coarse location module 316 tracks the geolocation of the player and provides the player geolocation information to the gaming module 314. The gaming module 314 updates the player position in the virtual world associated with the game based on the geolocation of the player in the real world. Thus, a player can interact with the virtual world simply by carrying or transporting the client device 310 in the real world. In particular, the position of the player in the virtual world can correspond to the geolocation of the player in the real world. The gaming module 314 can provide player location information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The positioning module 318 provides an additional or alternative way to determine the location of the client device 310. In one embodiment, the positioning module 318 receives the coarse location determined for the client device 310 by the coarse location module 316 and refines it by determining a pose of one or more cameras of the camera assembly 312. The positioning module 318 may use the location generated by the coarse location module 316 to select a 3D map of the environment surrounding the client device 310 and use the 3D map for localization based on images captured by the camera assembly 312. In some embodiments, the positioning module 318 may also perform tracking based on images captured by the camera assembly and sensor data captured by the additional sensors 313 (e.g., inertial data).

In one embodiment, the positioning module 318 applies a trained model to determine the pose of images captured by the camera assembly 312 relative to the 3D map. Thus, the positioning module 318 can determine an accurate (e.g., to within a few centimeters and degrees) determination of the position and orientation of the client device 310. The position of the client device 310 can then be tracked over time using dead reckoning based on sensor readings, periodic re-localization, or a combination of both.

With the accurate pose information, the gaming module 314 can present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly. As the user moves around the environment, the real-time pose information is key to preventing misalignment of the virtual object placement.

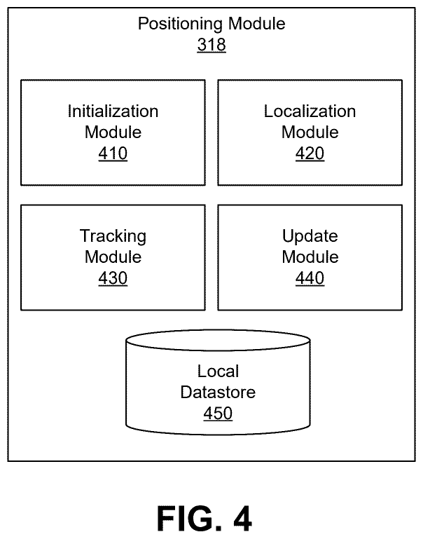

Various embodiments of the positioning module 318 are escribed in greater detail below, with reference to FIG. 4.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping module 327, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping module 327 manages 3D maps of areas (e.g., stored in the 3D map store 329) and can provide these 3D maps to client devices 310. Each map may be associated with a geographic location, such as GPS coordinates indicating a center or other origin point of the 3D map, a set of GPS coordinates defining an edge of the 3D map, or any other indication of the geographic location of the area represented by the 3D map. In one embodiment, the mapping module 327 receives a request for a 3D map that includes a coarse location of a client device 310 and provides the 3D map that most closely matches the coarse location (e.g., a 3D map for an area that encompasses the coarse location or for which the origin point is within a threshold distance of the coarse location, etc.).

In various embodiments, a 3D map is a point cloud that represents the physical structure and appearance of a corresponding area. Each 3D point in the cloud may correspond to a visually identifiable point in the area identified from one or more video scans of the area. Each 3D point includes a descriptor that represents the appearance of the visually identifiable point. The descriptor may be a binary string of features determined from the video scans. Thus, the descriptors contain sufficient information for performing localization using new images of the area without needing the original image frames from the video scans that were used to generate the 3D points and descriptors. In other embodiments, other representations of 3D map may be used, such as a neural network-based map.

The mapping module 327 may curate a global map for an area, based on updates from one or more client devices. The mapping module 327 may aggregate updates across client devices to refine the global map. In some embodiments, the mapping module 327 may weight client device updates based on confidence scores calculated by the client device, e.g., during localization, tracking, or some combination thereof. The mapping module 327 may also weight updates based on recency, e.g., recent updates are weighted higher than older updates. The mapping module 327 may periodically refine the global map for the area, pushing out the global map for the area to client devices for on-device localization.

The 3D map store 329 includes one or more non-transitory computer-readable media that store the 3D maps provided by the mapping module 327 to client devices 310. Although the 3D map store 329 is shown as a single entity that is part of the game server 320, it may split across multiple non-transitory computer-readable media, some or all of which may be located remotely from the game server 320 (e.g., as part of the game database 330).

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

FIG. 4 illustrates one embodiment of the positioning module 318 of a client device 310. In the embodiment shown, the positioning module 318 includes an initialization module 410, a localization module 420, a tracking module 430, an update module 440, and a local data store 450. In other embodiments, the localization module 318 includes different or additional elements. In addition, the functions may be distributed among the elements in a different manner than described.

The initialization module 410 obtains an initial map for the area surrounding the client device. In one embodiment, the initialization module 410 obtains a coarse location (e.g., a GPS position) from the coarse location module 316 and sends a request for the initial map to the game server 320. The game server 320 provides a map for an area surrounding or near the coarse location of the client device 310. As described previously, the map may include a cloud of 3D points, with each point having a 3D position indicating a point in the real world to which it corresponds and a descriptor that is a binary string of features describing the appearance of the corresponding real-world point. The 3D points may be described in a global coordinate system. The 3D points may indicate the three-dimensional spatial position of the point in the coordinate system. In some embodiments, the 3D map may further describe relative distances between points in the 3D map. For example, point 1 and point 2 are positioned 35 distance units apart. In some embodiments, the 3D map may further group points together as belonging to objects in the environment.

In one or more embodiments, the map of an area may be partitioned into chunks. The client device may obtain a subset of the chunks for the map of the area, e.g., for efficient transmission from the server and/or efficient storage on on-device memory. As the client device moves about the area, the client device may request additional chunks and/or delete chunks from memory to aid in efficient storage of chunks. For example, the client device may store up to five chunks of the map at a time. At initialization, the client device may obtain three chunks closest in proximity to the client device. As the client device moves to a new position, the client device may obtain additional one or more chunks for the new position. To stay under the tolerance, the client device may delete or remove one or more chunks associated with the prior position.

In one or more embodiments, the 3D map may be a mesh comprising vertices and edges connecting vertices in a spatial coordinate system. The mesh may include information on surfaces in the environment, providing added details on object geometry. Each vertex in the mesh may be assigned a specific elevation value, such that the mesh models the contours, slopes, and variations in the one or more surfaces in the environment. The mesh may be visualized as a collection of triangles, quadrilaterals, or other polygons that together approximate the shape of objects in the environment. This structure provides detailed analysis and visualization of physical objects in the environment. In one or more embodiments, the 3D map may be a hybrid representation of one or more forms of spatial modeling. For example, the 3D map may be a hybrid form of point cloud and polygon mesh. Polygon meshes are advantageous for representing large, relatively flat surfaces, in a low computational cost manner. Point clouds are advantageous for capturing granular detail for irregular surfaces that can be hard to represent through the mesh, though in a high computational cost manner. Representing certain portions with the point cloud form preserves the fine details, while representing other portions with the mesh provides computational cost savings.

The localization module 420 compares an image captured by the camera assembly 312 to the initial map to determine an initial pose of the client device 310. In one embodiment, the localization module 420 compares patches of the image to the 3D point descriptors to find a pose that best aligns the content of the image(s) with the 3D map. The patches are portions of image (e.g., N×M pixel rectangles or squares, where N and M are typically between three and ten) that can be compared the descriptors for 3D points to determine how likely it is that the patch depicts the real-world point corresponding to the descriptor. A fitting algorithm such as RANSAC may be used to find the pose that best explains the matches (and mismatches) between patches and 3D points. In one or more embodiments, the localization module 420 uses perspective-n-point (PnP) algorithm to estimate the initial pose of the client device 310, which inputs the 2D points in the captured image and the 3D points in the 3D map. The PnP algorithm outputs the camera position and the camera orientation, i.e., the pose of camera, based on the point correspondences. In one or more embodiments, the localization module 420 may perform pose refinement using non-linear optimization, e.g., bundle adjustment to minimize reprojection error. For example, the localization module 420 can perform iterative closest point using optionally available depth data. In other embodiments, the localization module 420 may use other sensor data to help estimate the pose. For example, the localization module 420 may use inertial measurement unit data, odometry data, depth data (e.g., LIDAR, RADAR, SONAR, etc.), magnetometer data, gyroscope data, etc.

The tracking module 430 tracks the pose of the client device 310 after the localization module 420 as determined its initial location. In one embodiment, the tracking module 430 obtains images captured by the camera assembly 312 and inertial data from one or more additional sensors 313 (e.g., from an inertial measurement unit (IMU)) indicating movement of the client device 310. The tracking module 430 determines a pose by comparing patches of the images to the 3D map in a similar manner to the localization module 420, but weights possible poses based on the inertial data. Specifically, the tracking module 430 uses the previously determined pose and the inertial data to determine likely poses. To provide a simplified example, if the inertial data indicates the client device 310 has moved three centimeters since the previous localization and the localization process identifies one pose that is two centimeters away from the previous location and another that is ten centimeters away from the previous location, the former is more likely to be correct and may be selected. The tracking module 430 may localize against every image captured by the camera assembly or a subset of those images (e.g., every second or third image, any image that is captured immediately after the previous localization is completed, or when the inertial data indicates the client device 310 has moved more than a threshold amount, etc.).

With the 3D map loaded locally on the client device, the tracking module 430 (in conjunction with the localization module 420) may periodically perform relocalization against the 3D map, thereby grounding the tracking in the higher accuracy pose estimates. Moreover, storing the 3D map locally reduces dependency of the localization to the game server, whereas other localization paradigms would require maintaining connectivity to the game server for querying the game server for localization of a captured image.

The update module 440 enables the initial map obtained by the initialization module 410 to be updated locally on the client device 310. The update module 440 may also provide the updated map to the game server 320, which may provide it to other players' devices. Thus, updates to the 3D map may be crowdsourced and the 3D map for the area may expand or evolve over time. In one embodiment, the update module 440 generates new 3D points and the corresponding descriptors based on a set of images (e.g., a video) of the area captured by the camera assembly 312 as the user moves around the area. Thus, the 3D map can be expanded to include new features (e.g., a bench that was added, a crack that opened up, or a new mural) or expand the area covered by the map (e.g., if the user leaves the area covered by the initial map). Or, in some cases, objects may be moved or modified. The updates to the 3D map may be transmitted to the game server, for updating the global 3D map stored by the game server.

The 3D points and descriptors generated by the update module 440 may have the same format as the initial map downloaded by the initialization module 410. Thus, the updated map may be uploaded to the game server 320 to be provided to other users to benefit from the updated visual information. Since only the position of the new 3D points and the descriptor is used once the map is created (and not the original camera feed), the bandwidth required to provide the updated map to the game server 320 is relatively modest. In some embodiments, the update module 440 may upload only the newly created 3D points and descriptors, with the position of the 3D points indicating where they fit into the larger map. Furthermore, user privacy concerns may be addressed as the images are not provided to the game server 320.

The local data store 450 includes one or more non-transitory computer readable media on which the data used by the other modules of the positioning module 318 may be stored. In one embodiment, the local data store 450 includes a local copy of the 3D map being used for localization and tracking. Furthermore, updates to the map can initially be stored in the local data store 450 and later uploaded to the game server 320 to update the 3D map store 329. For example, map updates may be uploaded as soon as they are generated (or as soon as a network connection is available after generation), at the end of an AR session, or in response to user input.

### Example Methods

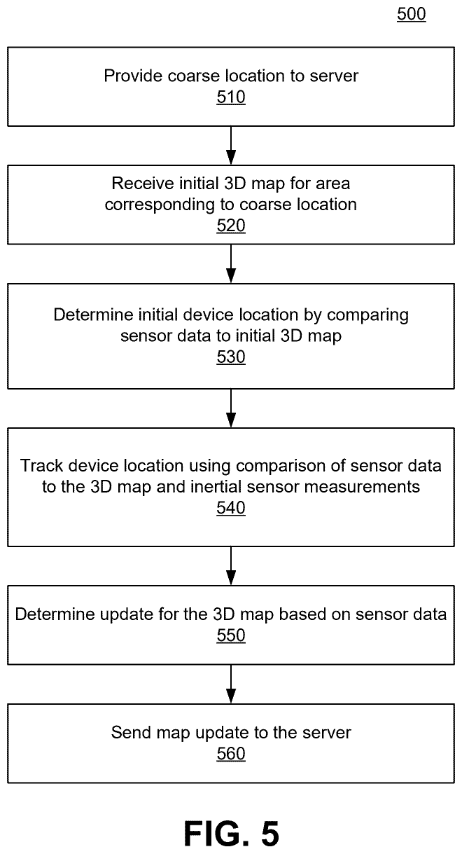

FIG. 5 is a flowchart describing an example method 500 of providing on-device localization and tracking, according to one embodiment. The steps of FIG. 5 are illustrated from the perspective of various components of the positioning module 318 performing the method 500. However, some or all of the steps may be performed by other entities or components. In addition, some embodiments may perform the steps in parallel, perform the steps in different orders, or perform different steps.

In the embodiment shown, the method 500 begins with the initialization module 410 providing 510 a coarse location (e.g., GPS coordinates) of the client device 310 to the game server 320. In response, the initialization module 410 receives 520 an initial 3D map for an area corresponding to the provided coarse location. The area may be a geographic area that encompasses the coarse location or may be one that is closest to the provided coarse location. In some embodiments, the game server 320 returns an error indicating no 3D maps are available if the closest 3D is more than a threshold distance away from the provided coarse location.

Assuming a 3D map is received, the localization module 420 determines 530 an initial location (e.g., pose) for the client device 310 by comparing sensor data to the 3D map. In one embodiment, the comparison is of patches of an image captured by the camera assembly to visual descriptors of 3D points in the map, as described previously. Additionally or alternatively, other types of sensor data may be compared to the 3D map so long as the 3D map includes a descriptor that indicates that readings to expect by the relevant sensor from different 3D points in the area.

Once an initial location has been determined 530, the tracking module 430 tracks 540 the location of the client device. In one embodiment, the tracking module 430 tracks 540 the device location using a combination of inertial data and a comparison of sensor data (e.g., images captured by the camera assembly 312) to the descriptors in the 3D map. As described previously, the inertial data may be used to improve calculation efficiency by limiting the comparison of sensor data to the 3D map to considering just a subset of the 3D points that are in the approximate location indicated by the inertial data and the previously determined location.

In some embodiments, the update module 440 may dynamically determine 550 one or more updates for the 3D map based on sensor data. For example, the update module may determine new 3D points and descriptors (or update the descriptors of existing 3D points) based on a series of images (e.g., a video) captured by the camera assembly as the user moves around the area. The update module 440 may send 560 a map update including the new (or updated) 3D points to the game server 320 (e.g., for storage in the 3D map store 390 and later provision to other users' client devices 310).

### Example Computing System

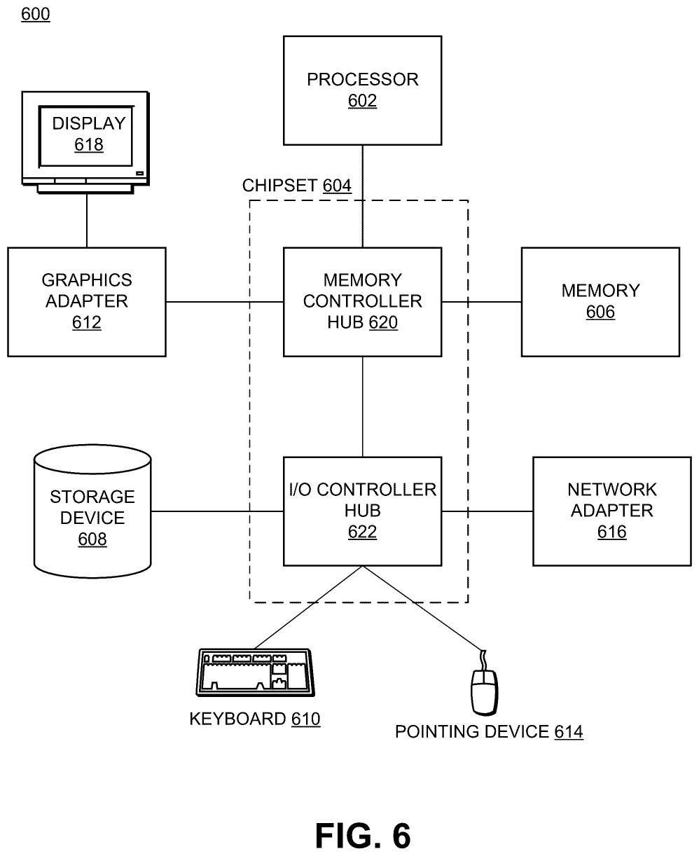

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touchscreen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIGS. 3 and 4 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by any claims that ultimately issue.

What is claimed is:

1. A computer-implemented method comprising:
obtaining an initial 3D map for an area corresponding to a coarse location of a physical world of the client device, the initial 3D map including a plurality of features;
determining, by the client device, an initial pose of the client device by comparing sensor data to the 3D map without sending any keyframe to a server;
tracking, by the client device, the pose of the client device over time using inertial data indicating motion of the client device and a comparison of additional sensor data to the 3D map;
generating, by the client device, virtual content based on the initial pose and tracked pose; and
displaying, on an electronic display of the client device, the virtual content.

2. The computer-implemented method of claim 1, wherein obtaining the initial 3D map for the area corresponding to the coarse location of the physical world of the client device comprises:
determining, by the client device, the coarse location in the physical world using a global positioning system (GPS) receiver;
providing, by the client device, the coarse location to a server; and
receiving, by the client device, the initial 3D map from the server.

3. The computer-implemented method of claim 1, wherein the 3D map is a point cloud comprising a plurality of 3D points representing objects in the area corresponding to the coarse location of the physical world.

4. The computer-implemented method of claim 3, wherein each 3D point including a descriptor having data describing a visual appearance of a corresponding real-world point.

5. The computer-implemented method of claim 3, further comprising:
capturing, by a camera assembly of the client device, an image of the area as the sensor data, wherein determining the initial pose is based on the image of the area.

6. The computer-implemented method of claim 5, wherein determining the initial pose based on the image of the area comprises:
identifying a subset of one or more features of the 3D map from the image of the area; and
determining the initial pose by projecting the subset of one or more features from the 3D map onto the image of the area.

7. The computer-implemented method of claim 5, wherein generating the virtual content comprises:
generating one or more virtual objects based on the initial pose and the tracked pose; and
augmenting the image of the area with the one or more virtual objects.

8. The computer-implemented method of claim 1, wherein the 3D map is a polygon mesh comprising a plurality of vertices and a plurality of edges representing surfaces in the area corresponding to the coarse location of the physical world.

9. The computer-implemented method of claim 1, further comprising:
determining, by the client device, an update to the 3D map based on further sensor data; and
sending the update to the 3D map to the server.

10. The computer-implemented method of claim 9, further comprising:
capturing, by a camera assembly of the client device, video of the area as the further sensor data, wherein determining the update to the 3D map is based on the video captured by the camera assembly.

11. A non-transitory computer-readable storage medium storing instructions that, when executed by a computer processor, cause the computer processor to perform operations comprising:
obtaining an initial 3D map for an area corresponding to a coarse location of a physical world of the client device, the initial 3D map including a plurality of features;
determining, by the client device, an initial pose of the client device by comparing sensor data to the 3D map without sending any keyframe to a server;
tracking, by the client device, the pose of the client device over time using inertial data indicating motion of the client device and a comparison of additional sensor data to the 3D map;
generating, by the client device, virtual content based on the initial pose and tracked pose; and
displaying, on an electronic display of the client device, the virtual content.

12. The non-transitory computer-readable storage medium of claim 11, wherein obtaining the initial 3D map for the area corresponding to the coarse location of the physical world of the client device comprises:
determining, by the client device, the coarse location in the physical world using a global positioning system (GPS) receiver;
providing, by the client device, the coarse location to a server; and
receiving, by the client device, the initial 3D map from the server.

13. The non-transitory computer-readable storage medium of claim 11, wherein the 3D map is a point cloud comprising a plurality of 3D points representing objects in the area corresponding to the coarse location of the physical world.

14. The non-transitory computer-readable storage medium of claim 13, wherein each 3D point including a descriptor having data describing a visual appearance of a corresponding real-world point.

15. The non-transitory computer-readable storage medium of claim 13, the operations further comprising:
capturing, by a camera assembly of the client device, an image of the area as the sensor data, wherein determining the initial pose is based on the image of the area.

16. The non-transitory computer-readable storage medium of claim 15, wherein determining the initial pose based on the image of the area comprises:
identifying a subset of one or more features of the 3D map from the image of the area; and
determining the initial pose by projecting the subset of one or more features from the 3D map onto the image of the area.

17. The non-transitory computer-readable storage medium of claim 15, wherein generating the virtual content comprises:
generating one or more virtual objects based on the initial pose and the tracked pose; and
augmenting the image of the area with the one or more virtual objects.

18. The non-transitory computer-readable storage medium of claim 11, wherein the 3D map is a polygon mesh comprising a plurality of vertices and a plurality of edges representing surfaces in the area corresponding to the coarse location of the physical world.

19. The non-transitory computer-readable storage medium of claim 11, the operations further comprising:
determining, by the client device, an update to the 3D map based on further sensor data; and
sending the update to the 3D map to the server.

20. The non-transitory computer-readable storage medium of claim 19, the operations further comprising:
capturing, by a camera assembly of the client device, video of the area as the further sensor data, wherein determining the update to the 3D map is based on the video captured by the camera assembly.
